(19) United States
(12) Patent Application Publication
(10) Pub. No.: US 2025/0376199 A1
(43) Pub. Date: Dec. 11, 2025

(54) TRAIN OPERATION INTELLIGENT DISPATCHING SYSTEM AND METHOD

(71) Applicant: CASCO SIGNAL LTD., Shanghai (CN)

(72) Inventors: Li LIN, Shanghai (CN); Bingjian Zhang, Shanghai (CN); Jiafeng Guo, Shanghai (CN); Enhua Hu, Shanghai (CN); Jiang Qian, Shanghai (CN); Xulan He, Shanghai (CN); Bingfeng Zhang, Shanghai (CN); Jiafu Pei, Shanghai (CN)

(73) Assignee: CASCO SIGNAL LTD., Shanghai (CN)

(21) Appl. No.: 19/307,125

(22) Filed: Aug. 22, 2025

Related U.S. Application Data
(63) Continuation-in-part of application No. PCT/CN2023/135403, filed on Nov. 30, 2023.

(30) Foreign Application Priority Data
Mar. 22, 2023 (CN) 202310288783.7

(51) Int. Cl. B61L 27/20; B61L 27/10

(52) U.S. Cl. CPC B61L 27/20; B61L 27/10

(57) ABSTRACT

A train operation intelligent dispatching system and method are provided, where the system includes: a data acquisition and control module, configured to collect multi-source data affecting train operation; a data processing module, configured to perform data aggregation on the multi-source data, and process the multi-source data to form multi-source data in a unified data format; a multi-disciplinary data resource pool, configured to perform real-time storage and updating of the multi-source data in the unified data format, and store historical multi-source data; an intelligent fault analysis module, having intelligent fault analysis models therein, configured to perform fault analysis based on the multi-source data to obtain fault analysis results of corresponding disciplinary systems, and output fault advance warnings of corresponding disciplinary systems according to the fault analysis results; and a process preplan module, configured to provide preplan handling processes corresponding one-to-one with external multi-disciplinary systems.

### CROSS-REFERENCE TO THE RELATED APPLICATIONS

This application is a continuation-in-part application of International Application No. PCT/CN2023/135403, filed on Nov. 30, 2023, which is based upon and claims priority to Chinese Patent Application No. 202310288783.7, filed on Mar. 22, 2023, the entire contents of which are incorporated herein by reference.

### TECHNICAL FIELD

The present disclosure relates to the technical field of rail transit, and particularly relates to a train operation intelligent dispatching system and method for rail transit faults and emergency situations.

### BACKGROUND

Referring to “Human Factors Analysis and Countermeasures for Urban Rail Transit Operational Accidents,” the statistical analysis results of 153 operational incidents in urban rail transit both domestically and internationally show that device faults account for approximately 31%, management factors for about 7%, human factors for about 51%, and other factors for about 11%. It can be seen that human factors and device faults are the main causes of operational accidents. On the other hand, the fully automatic driverless mode has become the mainstream mode in current urban rail transit construction. In the fully automatic driverless scenario, the driver configuration is eliminated, and operational efficiency is significantly improved compared to the conventional Communication Based Train Control System (CBTC) mode. However, it also brings new problems, such as the driver's responsibilities must be taken over by dispatch personnel in the control center. This significantly increases the labor intensity of the dispatch personnel, and when faults occur, the dispatch personnel also need to handle the faults quickly. In the absence of a driver on the train, how to quickly enable the dispatch personnel in the control center to grasp the on-site situation and how to quickly allow the dispatch personnel in the control center to perform fault handling and restore operation has become a major issue that must be overcome.

### SUMMARY

The purpose of the present disclosure is to provide dispatch personnel in the control center with a train operation intelligent dispatching system and method for rail transit faults and emergency situations. The system and method help the dispatch personnel in the control center to quickly detect faults, quickly handle faults, quickly restore operation, and reduce troubleshooting time, thereby improving overall operational efficiency and enhancing operational safety.

To achieve the above purpose, the present disclosure is implemented through the following technical solution:

A train operation intelligent dispatching system, comprising: a data acquisition and control module configured to collect multi-source data affecting train operation; a data processing module configured to perform data aggregation and process the multi-source data to form multi-source data in a unified data format; a multi-disciplinary data resource pool configured to save and update the multi-source data in the unified data format in real time, and to store historical multi-source data; an intelligent fault analysis module having intelligent fault analysis models for external multi-disciplinary systems, configured to perform fault analysis based on the multi-source data stored in the multi-disciplinary data resource pool to obtain fault analysis results corresponding to the external multi-disciplinary systems, and to output fault advance warnings corresponding to the external multi-disciplinary systems based on the fault analysis results; the fault advance warnings including general fault alarms and preplan alarms; and a process preplan module, configured to provide preplan handling processes corresponding one-to-one with the external multi-disciplinary systems, perform fault troubleshooting on a device in the disciplinary system, and adjust a train operation dispatching plan according to the preplan handling process.

Optionally, the train operation intelligent dispatching system further comprises: a device initialization module connected to the data acquisition and control module, the device initialization module being configured to initialize initial information of the train operation intelligent dispatching system itself, including: external interface protocols, connection parameters, acquisition cycles, and configuration parameter loading of each module. The data acquisition and control module is configured to communicate with the external multi-disciplinary systems according to the initial information, and collect the multi-source data affecting the train operation.

Optionally, the external multi-disciplinary systems include: a signaling system, a power supply system, an electromechanical system, a platform screen door system, a fire alarm system (FAS), and a vehicle system. The multi-source data include: turnout faults, interlocking device faults, catenary switches and electrified states, tunnel fans, fire alarms, platform screen door fault information, civil defense door status, anti-flooding door status, train traction and auxiliary system fault information.

Optionally, the train operation intelligent dispatching system further includes a status buffer zone connected to both the data acquisition and control module and the data processing module, the status buffer zone being configured to receive and temporarily store the multi-source data sent by the data acquisition and control module.

Optionally, the intelligent analysis model is established according to specific types of the external multi-disciplinary systems and in combination with operational guidance rules of a user.

Optionally, according to the general fault alarm, the data acquisition and control module is configured to send a command through the signaling system to a train, allowing the train to continue operating until the end of operation for processing.

Optionally, the intelligent fault analysis module is specifically configured to: compare the multi-source data, including real-time status quantities and analog quantities acquired, with the intelligent analysis model of the corresponding disciplinary system in real time.

When a real-time analog quantity curve or a status quantity change does not conform to the intelligent analysis model of the corresponding disciplinary system, a fault advance warning for the disciplinary system is generated, indicating that the disciplinary system may be faulty.

In combination with big data analytics technology, statistical analysis is performed on historical fault situations of similar disciplinary systems to generate fault advance warnings for potential faults in the similar disciplinary systems.

According to the generated fault advance warnings and in combination with operational guidance rules, analysis is performed on whether the faults that have occurred affect operation; if the faults affect operation, a preplan alarm for the fault is generated.

Optionally, the process preplan module is specifically configured to: implement the preplan handling process including major process nodes and detailed process nodes; the relationship between the major process nodes and the detailed process nodes is as follows: the major process nodes are key steps in the entire process, through which steps of the detailed process nodes can be located; and through the major process nodes, steps of the detailed process nodes can be skipped. Different dispatching positions in a dispatching center can open the same process object and perform collaborative preplan handling according to their respective permissions. Each step in the preplan handling process can be marked as executed or unexecuted. Executed steps need to be clearly distinguished from unexecuted steps by color marking.

Optionally, the process preplan module is further specifically configured to: define preconditions for executing each step in the preplan handling process, and only when these preconditions are met can the step be executed.

Optionally, the process preplan module executes each step, performs necessary precondition checks through the intelligent fault analysis module, displays the status of these preconditions, and provides an indication of whether the conditions for executing the step are met. According to the needs of the preplan handling process, operations required to be executed by dispatch personnel are defined for each step in the preplan handling process. According to a faulty device and a location of the fault, devices required to be operated are automatically determined.

Optionally, the process preplan module is further configured to dynamically subscribe to device status displays of related preconditions required for each step in the preplan handling process; and to dynamically subscribe to device status displays of the devices on which the operations are executed after the corresponding operations are executed by each step.

Optionally, when operational adjustment is needed, the process preplan module provides specific operational route adjustment suggestions based on the device with the specific fault, for decision-making by the dispatch personnel.

When a faulty train needs rescue, the process preplan module automatically searches out leading and following trains according to train information obtained by the data acquisition and control module, gives a suggestion for selecting a rescue train at a train adjustment node in the preplan handling process, and dispatching personnel can select a train as the rescue train to perform subsequent rescue operations.

Optionally, the rescue operations required to be executed by the dispatch personnel include: calling train crew, train holding, passenger evacuation, pantograph raising/lowering, video retrieval, OV cabinet operation, and activating tunnel fan functions.

Optionally, the train operation dispatching plans include: “prevention of inter-section forced stop through automatic holding of following trains,” “system-wide coordinated slow speed train operation,” “rapid withdrawal of faulty train,” “rapid deployment of standby train,” “early turnback substitution,” and “system-wide train routes automatic adjustment for partial service disruptions.”

Optionally, when a fault handling duration of a train is prolonged, a strategy command of “prevention of inter-section forced stop through automatic holding of following trains” is provided, that is, during a period when a leading train cannot depart on time due to a reason, all following trains are automatically held at platforms one station apart according to a predetermined strategy, to avoid the following trains entering a section and waiting in a tunnel section for an extended period.

When the train fault handling dwell time is long, a strategy command of “system-wide coordinated slow speed train operation” is provided, according to the analyzed fault train handling time and impact range, automatically calculating the station dwell time of all trains on the whole line to be extended successively, so as to maintain the headway on the whole line, and quickly restore the headway of the train schedule after the train fault is restored. A strategy command of “rapid withdrawal of faulty train” is provided to achieve rapid withdrawal of the faulty train from operation. A strategy command of “rapid deployment of standby train” is provided to quickly arrange a standby train located on a main line storage track or in a depot/yard to enter operational passenger service on time and at a designated location. A strategy command of “early turnback substitution” is provided, when a large train interval occurs in one operating direction due to a fault affecting passenger service, quickly arranging a train with lower passenger flow demand in the opposite direction to perform an early turnback using a crossover track between up and down lines, compensating for the train interval in the faulty direction. A strategy command of “system-wide train routes automatic adjustment for partial service disruptions” is provided, when severe facility or device faults occur in a partial section of the line causing trains to be unable to pass, providing one-click decision implementation for the dispatch personnel while coordinating all system-wide trains to switch to new route paths for operation.

Optionally, the general fault alarms and the preplan alarms of all disciplinary systems are uniformly displayed in an emergency panoramic view.

Optionally, a monitoring scope of the emergency panoramic view mainly includes: turnout indications, signal indications, track section occupancy status indications, turnout normal/faulty states, axle counter normal/failed signaling system device states, SPKS status, dynamic train positions, catenary power supply modes, station/section fires, section water levels, civil defense door status, platform emergency shutdowns, platform screen door normal/faulty states, person or object trapped by platform screen doors, and train normal/faulty states.

Optionally, when a fault affecting operation occurs, a faulty device in a main display area of an interface of the emergency panoramic view should flash in red, accompanied by audible and visual alarms.

Optionally, through the faulty device in the emergency panoramic view, navigation to a detailed fault page is enabled.

Optionally, the detailed fault page displays possible fault causes and estimated maintenance times calculated based on historical experience values. The detailed fault page displays TOP rankings for section parking timeouts, TOP rankings for real-time platform departure delays, train delay deviations, current station entry and exit passenger flows, and current train load factor metrics.

Optionally, the corresponding faulty device quickly opens a preplan process handling interface through the process preplan module to initiate preplan process handling.

On the other hand, the present disclosure further provides a method for train operation intelligent dispatching based on the train operation intelligent dispatching system described above, comprising: collecting multi-source data affecting train operation; performing data aggregation and processing the multi-source data to form multi-source data in a unified data format; saving and updating the multi-source data in the unified data format in real time, and storing historical multi-source data; establishing intelligent fault analysis models for external multi-disciplinary systems; performing fault analysis based on the multi-source data stored in the multi-disciplinary data resource pool to obtain fault analysis results corresponding to the external multi-disciplinary systems, and outputting fault advance warnings corresponding to devices based on the fault analysis results; generating a preplan alarm when the fault advance warning affects operation; and providing preplan handling processes corresponding one-to-one with the external multi-disciplinary systems based on the preplan alarm, performing fault troubleshooting on the devices according to the preplan handling processes, and adjusting train operation dispatching plans.

Optionally, the method further comprises generating a general fault alarm when the fault advance warning does not affect operation, prompting the dispatch personnel to allow continued operation until the end of operation for processing.

Optionally, the method further comprises uniformly displaying the general fault alarms and the preplan alarms of all disciplinary systems in the emergency panoramic view.

Compared with existing technology, the present disclosure has one of the following technical effects:

The present disclosure provides a train operation intelligent dispatching system for rail transit faults and emergency situations.

The train operation intelligent dispatching system establishes a multi-disciplinary data resource pool for storing multi-source data from multiple disciplines that may affect train operation, which is necessary for train dispatching.

In combination with operational guidance rules of the user, intelligent fault analysis models are established for different external multi-disciplinary systems, realizing fault advance warning functions, fault location functions, and preplan alarm issuance functions.

The train operation intelligent dispatching system, through the emergency panoramic view, referred to as “one diagram for emergencies”, enables the dispatch personnel to comprehensively grasp current operational conditions, fault conditions, and restoration conditions.

The train operation intelligent dispatching system provides a “one device, one preplan” function, allowing the dispatch personnel to quickly initiate a process preplan for fault troubleshooting and rapidly restore operation.

In each step of the process preplan, the train operation intelligent dispatching system can define operations required to be executed by the dispatch personnel, such as calling train crew, train holding, passenger evacuation, pantograph raising/lowering, video retrieval, OV cabinet operation, and activating tunnel fan functions. The train operation intelligent dispatching system can automatically determine devices required to be operated based on the faulty device and the fault location, for example, for train holding, the train operation intelligent dispatching system automatically identifies a platform where train holding is needed, and the dispatch personnel execute one-click train holding. These operations can be executed in batches, such as batch train holding and batch pantograph raising/lowering.

The train operation intelligent dispatching system can dynamically subscribe to device status displays of related preconditions required for each step, such as whether a train is present in a turnout area, SPKS status, rail potential, section lighting, and tunnel fan status. The train operation intelligent dispatching system can dynamically subscribe to device status displays of the devices on which the operations are executed after the corresponding operations are executed by each step. For example: pantograph raising/lowering status, turnout status, video display, train holding platforms, etc.

The train operation intelligent dispatching system provides an operational decision-making function, providing specific operational route adjustment suggestions based on the device with the specific fault when operational adjustment is needed, for decision-making by the dispatch personnel.

When a faulty train requires rescue, the train operation intelligent dispatching system can automatically search for leading and following trains based on train operation information, provide suggestions for selecting a rescue train, and allow the dispatch personnel to select one train as the rescue train to execute subsequent rescue operations.

During operational fault handling, the train operation intelligent dispatching system provides intelligent operational dispatching functions under fault conditions, including “prevention of inter-section forced stop through automatic holding of following trains,” “system-wide coordinated slow speed train operation,” “rapid withdrawal of faulty train,” “rapid deployment of standby train,” “early turnback substitution,” and “system-wide train routes automatic adjustment for partial service disruptions,” to perform rapid train operation adjustments and rapidly restore operation.

### BRIEF DESCRIPTION OF THE DRAWINGS

FIG. 1 is a structural block diagram of a train operation intelligent dispatching system for rail transit faults and emergency situations provided by an embodiment of the present disclosure;

FIG. 2 is a flow chart of a method for train operation intelligent dispatching in the case of a rail transit fault and an emergency situation according to an embodiment of the present disclosure;

FIG. 3 is a flowchart block diagram of major process nodes of a catenary power loss preplan provided by an embodiment of the present disclosure;

FIG. 4 to FIG. 6 are flowchart block diagrams of detailed process nodes of the catenary power loss preplan provided by an embodiment of the present disclosure;

FIG. 7 is a flowchart of detailed process nodes of a turnout fault preplan provided by an embodiment of the present disclosure.

### DETAILED DESCRIPTION OF THE EMBODIMENTS

A train operation intelligent dispatching system and method for rail transit faults and emergency situations proposed by the present disclosure are further described in detail below in conjunction with the drawings and specific embodiments. The advantages and features of the present disclosure will become clearer based on the following description. It should be noted that the drawings are presented in a highly simplified form and utilize non-precise proportions, and are intended solely to facilitate a clear and concise explanation of the purpose of the embodiments of the present invention. To make the purposes, features, and advantages of the present disclosure more apparent and understandable, reference is made to the drawings. It is to be understood that, the structures, proportions, and sizes depicted in the drawings attached to this specification are merely used to cooperate with the content disclosed in the specification, for those skilled in the art to understand and read, and are not intended to limit the conditions under which the present disclosure can be implemented, thus lacking substantive technical significance. Any modifications to the structures, changes in proportional relationships, or adjustments in size, without affecting the effects and purposes achievable by the present disclosure, should still fall within the scope covered by the technical content disclosed by the present disclosure.

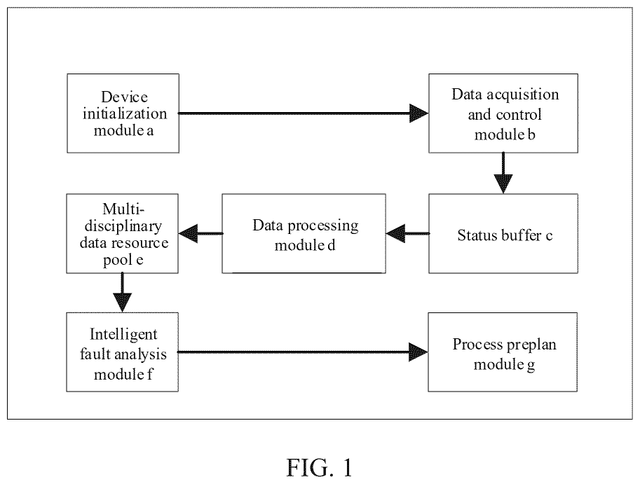

As shown in FIG. 1, a train operation intelligent dispatching system provided by the embodiment includes: a device initialization module a connected to a data acquisition and control module b, the device initialization module a being configured to initialize initial information of the train operation intelligent dispatching system itself, including: external interface protocols, connection parameters, acquisition cycles, and configuration parameter loading of each module.

The data acquisition and control module b is configured to collect multi-source data that may affect train operation; the data acquisition and control module b is specifically configured to communicate with external multi-disciplinary systems according to the initial information and collect the multi-source data that may affect train operation.

The external multi-disciplinary systems include: a signaling system, a power supply system, an electromechanical system, a platform screen door system, a fire alarm system (FAS), and a vehicle system, all arranged outside an existing train dispatching system; these disciplinary systems are existing systems and are not further elaborated here.

The multi-source data include: turnout faults, interlocking device faults, catenary switches and electrified states, tunnel fans, fire alarms, platform screen door fault information, civil defense door status, anti-flooding door status, train traction and auxiliary system fault information.

The present embodiment further includes a status buffer zone c, the status buffer zone c being connected to both the data acquisition and control module b and a data processing module d, the status buffer zone c being configured to receive and temporarily store the multi-source data sent by the data acquisition and control module b.

The data processing module d is configured to perform data aggregation and process the multi-source data to form multi-source data in a unified data format.

A multi-disciplinary data resource pool e is configured to save and update the multi-source data in the unified data format in real time, and to store historical multi-source data.

An intelligent fault analysis module f, equipped with intelligent fault analysis models for the external disciplinary systems, is configured to perform fault analysis based on the multi-source data stored in the multi-disciplinary data resource pool e to obtain fault analysis results for corresponding disciplinary systems, and to output fault advance warnings for the corresponding disciplinary systems based on the fault analysis results; the fault advance warnings include: general fault alarms and preplan alarms. The present embodiment enables realization of a fault advance warning function, a fault location function, and a preplan alarm issuance function.

The intelligent fault analysis model is established according to specific device types of the external disciplinary systems and in combination with operating rules of a user. Factors considered by the intelligent fault analysis model include, but are not limited to: device type, device location, fault phenomenon of a device, operational status of a device, and number of device faults. Faults can be categorized into single device faults and systemic faults; the establishment process of the intelligent fault analysis model is as follows:

For single-device faults:

Monitor operational status of a device in real time, collecting parameters such as current operating status, fault status, current operating voltage, current, and operating curves.

Employ a fault mechanism analysis method, extracting historical data of the device from the multi-disciplinary data resource pool, including time put into service, number of operations, voltage, current, operating curves, historical fault data, and maintenance records, to form health status assessment data for the device.

Employ a fault tree analysis method, for faults directly located to a specific device, further determine possible faulty devices and fault points (boards, sub-devices) of the device.

Employ a fault statistical analysis method, statistically analyze identical faults of similar devices; if operating curves and statuses of the device are found to be similar to existing faults of similar devices, but the device has not yet generated a fault alarm, generate an advance warning signal for a possible fault.

For systemic faults:

Employ a fault tree analysis method, through real-time collected data and fault alarms, perform cross-system analysis to determine whether a fault is likely caused by system A or system B; after locating a fault alarm to a system, further determine possible faulty devices.

Employ a fault mode analysis method, a fault impact analysis method, and a fault consequence analysis method, in combination with operating rule 1: number of faulty devices (e.g., if one traction inverter of a vehicle fails, maintain operation until the end of the day; if two traction inverters fail, withdraw from service at a terminal station; if three traction inverters fail, withdraw from service at a nearest station; if all traction inverters fail, the train cannot move and rescue is requested), to establish a systemic analysis model.

Employ a fault mode analysis method, a fault impact analysis method, and a fault consequence analysis method, in combination with operating rule 2: device location (e.g., if power supply arm S01 fails, trains on up (down) lines will turn back at track XX; if power supply arm S02 fails, short-turn operation between station XX and station XX will be adopted); according to different device locations, generate corresponding fault preplan alarms to prompt dispatch personnel to execute corresponding preplans, to establish a systemic analysis model.

The intelligent fault analysis module f is specifically configured to: compare the multi-source data, including real-time status quantities and analog quantities acquired, with the intelligent analysis model of the corresponding disciplinary system in real time; When a real-time analog quantity curve or a status quantity change does not conform to the intelligent analysis model of the corresponding disciplinary system, a fault advance warning for the disciplinary system is generated, indicating that the disciplinary system may be faulty. In combination with big data analytics technology, statistical analysis is performed on historical fault situations of similar disciplinary systems to generate fault advance warnings for potential faults in the similar disciplinary systems. According to the generated fault advance warnings and in combination with operational guidance rules, analysis is performed on whether the faults that have occurred affect operation; if the faults affect operation, a preplan alarm for the fault is generated. Alternatively, functions of the intelligent fault analysis module f are essentially identical to those of the intelligent fault analysis model.

A process preplan module g is configured to provide preplan handling processes corresponding one-to-one with the external disciplinary systems, to perform fault troubleshooting on devices in the disciplinary systems according to the preplan handling processes, and to adjust a train operation dispatching plan.

Improvements are made to an existing train operation dispatching system, the existing train operation dispatching system primarily collecting data related to a signaling system and providing train operation monitoring functions.

According to the general fault alarm, the data acquisition and control module b is configured to issue a command through the signaling system to a train, allowing the train to continue operating until the end of operation for handling.

In the present embodiment, the process preplan module g is specifically configured to: configure the preplan handling process to include major process nodes and detailed process nodes; the relationship between the major process nodes and the detailed process nodes is as follows: the major process nodes are key steps in the entire process, through which steps of the detailed process nodes can be located; steps of the detailed process nodes can be skipped through the major process nodes.

Different dispatch positions in a dispatch center can open the same process object, and perform coordinated preplan handling according to respective permissions; each step in the preplan handling process can be marked as executed or unexecuted; executed steps need to be clearly distinguished from unexecuted steps through color markings.

In the present embodiment, the process preplan module g is further specifically configured to: define preconditions for executing each step in the preplan handling process, wherein each step can only be executed when the preconditions are met.

In the present embodiment, the process preplan module g is configured to execute each step, perform necessary precondition checks through the intelligent fault analysis module f, display statuses of the preconditions, and provide prompts on whether conditions for executing the step are met. According to the needs of the preplan handling process, operations required to be executed by dispatch personnel are defined for each step in the preplan handling process. According to a faulty device and a location of the fault, devices required to be operated are automatically determined.

In the present embodiment, the process preplan module g is further configured to dynamically subscribe to device status displays of related preconditions required for each step in the preplan handling process; and dynamically subscribe to device status displays of the devices on which the operations are executed after the corresponding operations are executed by each step.

When operational adjustment is needed, the process preplan module g provides specific operational route adjustment suggestions based on a specific faulty device for decision-making by dispatch personnel.

When a faulty train requires rescue, the process preplan module g automatically searches for leading and following trains based on operating train information obtained by the data acquisition and control module b, provides suggestions for selecting a rescue train at a train operation adjustment node in the preplan handling process, and dispatch personnel can select a train as the rescue train to perform subsequent rescue operations.

In the embodiment, the rescue operations required to be performed by dispatching include: calling the train crew, train holding, passenger evacuation, pantograph raising/lowering, video retrieval, OV cabinet operation, and turning on the tunnel fan function. However, the present disclosure is not limited thereto; in some other embodiments, the dispatch personnel can also perform additional rescue operations.

In the present embodiment, the train operation dispatching plan includes: “prevention of inter-section forced stop through automatic holding of following trains,” “system-wide coordinated slow speed train operation,” “rapid withdrawal of faulty train,” “rapid deployment of standby train,” “early turnback substitution,” and “system-wide train routes automatic adjustment for partial service disruptions.”

In the embodiment, when the train fault handling dwell time is long, a strategy command of “prevention of inter-section forced stop through automatic holding of following trains” is provided, that is, when the preceding train cannot depart on time due to a fault, all following trains are automatically held at a platform of a station one station away according to a predetermined strategy, to avoid the following trains from entering the section and waiting in the tunnel section for a long time.

When the train fault handling dwell time is long, a strategy command of “system-wide coordinated slow speed train operation” is provided, according to the analyzed fault train handling time and impact range, automatically calculating the station dwell time of all trains on the whole line to be extended successively, so as to maintain the headway on the whole line, and quickly restore the headway of the train schedule after the train fault is restored.

A strategy command of “rapid withdrawal of faulty train” is provided to achieve rapid withdrawal of the faulty train from operation.

A strategy command of “rapid deployment of standby train” is provided to quickly arrange a standby train located on a main line storage track or in a depot/yard to enter operational passenger service on time and at a designated location.

A strategy command of “early turnback substitution” is provided, when a large train interval occurs in one operating direction due to a fault affecting passenger service, quickly arranging a train with lower passenger flow demand in the opposite direction to perform an early turnback using a crossover track between up and down lines, compensating for the train interval in the faulty direction.

A strategy command of “system-wide train routes automatic adjustment for partial service disruptions” is provided, when severe facility or device faults occur in a partial section of the line causing trains to be unable to pass, providing one-click decision implementation for the dispatch personnel while coordinating all system-wide trains to switch to new route paths for operation.

In the embodiment, the general fault alarms and the preplan alarms of all disciplinary systems are uniformly displayed in an emergency panoramic view. It can be understood that a fault alarm: a fault display generated after a real fault of the device; a preplan alarm: only a serious fault of device that affects operation will generate a preplan alarm.

In the embodiment, the monitoring scope of the emergency panoramic view mainly includes: turnout indication, signal indication, track section occupancy status indication, turnout normal/fault, axle counter normal/failed signaling system device status, SPKS status, train dynamic location, catenary power supply mode station/section fire, section water level, civil defense door status, platform emergency shutdown, platform screen door normal/fault, person or object trapped in platform screen door, and train normal/fault status.

In the embodiment, when a fault affecting operation occurs, the faulty device in the main display area of the emergency panoramic view should flash in red, accompanied by audible and visual alarms.

In the embodiment, through the corresponding device fault in the emergency panoramic view, one can navigate to a detailed fault page. It can be understood that, in the emergency panoramic view, only the fault of this device is displayed. The detailed fault page will display more detailed fault information. For example, for a train fault, in the emergency panoramic view, only the existence of a fault in a certain train is displayed; but in the detailed fault page, the specific faulty device of the train will be displayed: such as a traction inverter, or an auxiliary inverter.

In the embodiment, the fault page displays possible causes of the fault and possible maintenance time estimated based on historical experience. The detailed fault page displays TOP rankings for section parking timeouts, TOP rankings for real-time platform departure delays, train delay deviations, current station entry and exit passenger flows, and current train load factor metrics.

The present embodiment enables dispatch to fully grasp the current operating situation, fault situation, and recovery situation through an emergency panoramic view, that is, “one diagram for emergencies”.

In the embodiment, the corresponding faulty device (which can be understood as the professional system that generates the fault) quickly opens the preplan process handling interface through the process preplan module g, initiating preplan process handling.

The present embodiment provides the function of “one device, one preplan,” allowing dispatchers to quickly initiate a process preplan (preplan handling process) for troubleshooting and quickly restoring operation.

In the embodiment, the operations required to be performed by dispatchers can be defined in each step of the process preplan (preplan handling process), such as calling the train crew, train holding, passenger evacuation, pantograph raising/lowering, video retrieval, OV cabinet operation, and turning on the tunnel fan, among other functions. The present embodiment can automatically determine the device to be operated according to the faulty device and the location of the fault, for example, for train holding, the system automatically finds the platform where the train needs to be held, and the personnel performs one-click train holding. These operations can be executed in batches, such as batch train holding and batch pantograph raising/lowering.

The present embodiment can dynamically subscribe to the display of device status of relevant preconditions required for each step, such as whether there is a train in the turnout area, SPKS, rail potential, section lighting, section fan status, etc. The present embodiment can dynamically subscribe to the display of the status of the device being operated after each step performs the corresponding operation. For example: pantograph raising/lowering status, turnout status, video display, train holding platforms, etc.

Provide operational decision-making function, when operational adjustment is needed, the embodiment can provide specific operational route adjustment suggestions based on the device of the specific fault for dispatch decision-making.

When a faulty train needs rescue, the embodiment can automatically search for adjacent trains before and after according to the train operation information and provide suggestions for selecting a rescue train. The dispatch can select one train as a rescue train and execute the subsequent rescue operations.

In the process of operation fault handling, the embodiment provides intelligent operational dispatching functions under fault conditions, including “prevention of inter-section forced stop through automatic holding of following trains”, “system-wide coordinated slow speed train operation”, “rapid withdrawal of faulty train”, “rapid deployment of standby train”, “early turnback substitution” and “system-wide train routes automatic adjustment for partial service disruptions” functions, to carry out rapid train operation adjustment and quickly restore operation.

It can be understood that, in order to meet the functional needs of the train operation intelligent dispatching system, the hardware structure of the train operation intelligent dispatching system in the embodiment may also include a central processing unit (CPU), which is connected to the above-mentioned device initialization module a, data acquisition and control module b, status buffer zone c, data processing module d, multi-disciplinary data resource pool e, intelligent fault analysis module f and process preplan module g, respectively.

The central processing unit (CPU) can execute various appropriate actions and processing according to computer program instructions stored in a read-only memory (ROM) or computer program instructions loaded from a storage unit into a random access memory (RAM). In the RAM, various programs and data required for device operation can also be stored. The CPU, ROM, and RAM are connected to each other through a bus. An input/output (I/O) interface is also connected to the bus. In some embodiments, a storage unit is present, and part or all of the computer program can be loaded and/or installed onto the device via the ROM and/or the communication unit. When the computer program is loaded into RAM and executed by the CPU.

For the device initialization module a provided in the embodiment: the program instructions of the device initialization module a can be stored in the ROM, and these instruction sets are executed by the CPU to initialize the configuration information of the device itself, including external interface protocol, connection parameters, acquisition cycle, and configuration parameter loading of each module.

For the data acquisition and control module b provided in the embodiment: the CPU can execute program instructions related to the data acquisition and control module b according to the initial information loaded from the ROM, establish communication with external multi-disciplinary systems, acquire the status of external multi-disciplinary systems, and send control instructions to external multi-disciplinary systems.

For the data processing module d provided in the embodiment, the program instructions of the data processing module d can be stored in the ROM, and these instruction sets are executed by the CPU to implement the functions of the data processing module d.

For the status buffer zone c: the CPU in the process of processing instruction set programs, the status buffer zone c is also used for receiving and temporarily storing all temporary data in the processing process, to meet the needs of high-speed data exchange and ensure the timing of the system.

A certain storage space is opened up in the RAM for real-time storage and updating of the multi-source data after data processing, thereby forming the multi-disciplinary data resource pool e.

Intelligent fault analysis module f: establishes intelligent fault analysis models for different professional systems. These intelligent fault analysis models are stored in the ROM, and the CPU performs fault analysis by executing the intelligent fault analysis instruction sets stored in the ROM. The intelligent analysis model is established based on specific professional systems (devices) and is combined with the user's operating rules. Equipped with a fault alarm function; a fault advance warning function for potential faults that may occur; a fault localization function; and a preplan alarm generation function.

For the process preplan module g: based on the output of the intelligent fault analysis module f, the CPU executes the instruction set of the intelligent fault analysis module f stored in the ROM. When a fault affecting operation occurs, the process preplan module g automatically generates a preplan alarm (emergency preplan alarm), providing a “one device, one preplan” function, which can quickly initiate a process preplan for troubleshooting and quickly restore operation.

The system provided in the embodiment may also include a preplan alarm module, which is used for unified management of preplan alarms, including confirmation of alarms, whether the alarm has been cleared, quickly initiating a preplan process through a specific preplan alarm for troubleshooting, etc.

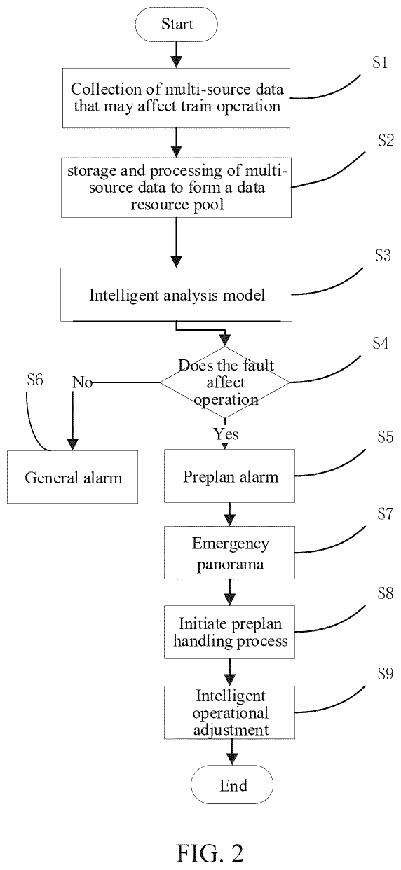

As shown in FIG. 2, a method for train operation intelligent dispatching based on the train operation intelligent dispatching system described above includes: Step S1: collecting multi-source data that may affect train operation from external multi-disciplinary systems.

The external multi-disciplinary systems include: a signaling system, a power supply system, an electromechanical system, a platform screen door system, a fire alarm system (FAS), and a vehicle system, all arranged outside an existing train dispatching system; these disciplinary systems are existing systems and are not further elaborated here. The multi-source data include: turnout faults, interlocking device faults, catenary switches and electrified states, tunnel fans, fire alarms, platform screen door fault information, civil defense door status, anti-flooding door status, train traction and auxiliary system fault information.

Step S2, aggregating and processing the multi-source data to form multi-source data in a unified data format; and performing real-time storage and updating of the multi-source data in the unified data format, as well as storing historical multi-source data to form a multi-disciplinary data resource pool.

Step S3, establishing intelligent fault analysis models for different professional systems; establishing fault analysis models based on specific professional systems and in combination with the user's operational guidance rules. The intelligent fault analysis model has a fault alarm function; a possible fault advance warning function; a fault localization function;

and a function to issue a preplan alarm.

The Step S3 further includes: step S31, establishing an intelligent fault analysis model according to the type of professional system.

Step S32, obtaining multi-source data of real-time state quantities and analog quantities of a specific professional system, and performing real-time data comparison with the intelligent fault analysis model of this professional system.

Step S33, when there is a real-time analog quantity curve or a change in a state quantity that does not conform to the intelligent analysis model of the corresponding professional system, generating a fault advance warning for this professional system, indicating a possible fault in this professional system.

Step S34, combining big data analytics technology (such as t-SNE pattern analysis, DBSCAN clustering, random forest algorithm, and other technologies) to statistically analyze historical fault situations of similar professional systems, and generates a fault advance warning of possible existing faults in similar professional systems.

Step S35, combining operational guidance rules, for faults that have already occurred, analyzing whether they affect operation, and if they affect operation, generating a preplan alarm and performing preplan linkage processing. For example, for a vehicle auxiliary inverter, according to operating rules, if one fails, operation can continue, and if three fail, the train needs to be taken out of service.

Step S4, performing fault analysis based on the multi-source data stored in the multi-disciplinary data resource pool to obtain a fault analysis result of the corresponding device, and outputting a fault advance warning of the corresponding device according to the fault analysis result; determining whether the fault reminded in the fault advance warning affects operation, if not, proceeding to step S5; if yes, proceeding to step S6.

Step S5, generating a general fault alarm information, prompting the dispatch to allow continued operation until the end of operation before handling.

Step S6, generating a preplan alarm.

Step S7, displaying all general fault alarms and the preplan alarms of all professional systems uniformly in an emergency panoramic view, through “one diagram for emergencies”, so that the dispatch can fully grasp the current operational situation, fault situation, and recovery situation.

The step S7 further includes: step S71, the monitoring scope of the mainly includes: turnout indication, signal indication, track section occupancy status indication, turnout normal/failure, axle counter normal/failed and other signaling system device statuses; SPKS (Staff Protection Key Switch for Unattended Train Operation) status; train dynamic location; catenary power supply mode (double-sided power supply, single-sided power supply, large double-sided power supply, power loss); station/section fire; section water level; civil defense door status; platform emergency shutdown; platform screen door normal/failure; platform screen door person or object trapped; train normal/fault status;

Step S72, when a fault affecting operation occurs, the faulty device in the main display area of the overall overview interface should flash red, and at the same time, be accompanied by audible and visual alarms.

Step S73, it is possible to navigate to a detailed fault page through the corresponding device (disciplinary system) fault.

Step S74, the fault page can display possible causes of the fault and possible maintenance time estimated based on historical experience values.

Step S75, the fault page can display the TOP ranking of section parking timeout, TOP ranking of real-time platform departure delay; train delay deviation, current station inbound and outbound passenger flow, current train load factor, and other indicators.

Step S76, it is possible to quickly open the preplan process handling interface through the corresponding fault professional system and initiate a preplan handling process.

Step S8, initiating a preplan handling process, that is, providing a preplan handling process corresponding one-to-one with the device.

The step S8 includes the following processes:

Step S81, the system provides a “one device, one preplan” function according to the specific device of the fault, and the process preplan guides the dispatch. When a fault occurs, operation is carried out according to the standard process, providing standardized process guidance, convenient operation methods, real-time progress and status of fault handling, and decision-making suggestions without panic.

Step S82, the preplan handling process has main process nodes and detailed process nodes, and it is possible to locate the steps corresponding to the detailed process nodes through the main process nodes; the preplan handling process includes main process nodes and detailed process nodes; the relationship between main process nodes and detailed process nodes: main process nodes are the key steps in the entire process, and it is possible to locate the steps of the detailed process nodes through the main process nodes; it is possible to skip certain steps of the detailed process nodes through the main process nodes.

Step S83, different dispatch positions in the dispatch center can open the same process object and carry out collaborative preplan handling according to their respective permissions. For example, if the catenary loses power, the train dispatch position and the power dispatch position open the same process object. According to the process steps, the train dispatch performs train-related handling, such as train holding, and the power dispatch performs power switch reclosing and other handling.

There is no need to close the interface content opened by multiple dispatch positions at the same time, and the system automatically refreshes the interface status;

Step S84, the process guidance can be marked as executed or not executed in a certain way (such as clicking the process line). Executed steps need to be clearly distinguished from unexecuted steps by color.

Step S85, when executing each step, the system performs necessary prerequisite checks, displays the status of these prerequisites, and gives a prompt as to whether the conditions for executing this step are met.

Step S86, according to the needs of the process guidance, the operations required by the dispatch can be defined in each step, such as calling the train crew, train holding, passenger evacuation, pantograph raising/lowering, video retrieval, OV (rail potential limiting device) cabinet operation, turning on the tunnel fan, and other functions. The train operation intelligent dispatching system can automatically determine devices required to be operated based on the faulty device and the fault location, for example, for train holding, the train operation intelligent dispatching system automatically identifies a platform where train holding is needed, and the dispatch personnel execute one-click train holding. These operations can be executed in batches, such as batch train holding and batch pantograph raising/lowering.

Step S87, the system can dynamically subscribe to the display of the device status of the relevant prerequisites required for each step, such as whether there is a train in the turnout area, SPKS (Staff Protection Key Switch for Unattended Train Operation), rail potential, section lighting, tunnel fan status, etc. The train operation intelligent dispatching system can dynamically subscribe to device status displays of the devices on which the operations are executed after the corresponding operations are executed by each step. For example: pantograph raising/lowering status, turnout status, video display, train holding platforms, etc.

Step S88, when operational adjustment is needed, the system can give specific operational route adjustment suggestions according to the specific faulty device, for dispatch decision-making. Multiple operational adjustment suggestions can be supported for the same fault. Operational adjustment suggestions are displayed graphically with text descriptions.

Step S89, when a rescue of a faulty train is needed, the system can automatically search for adjacent trains based on the running train information, give suggestions for the selection of a rescue train, and the dispatch can select a train as a rescue train to perform subsequent rescue operations.

Step S9, performing fault troubleshooting on the device according to the preplan handling process, and adjusting the train operation dispatching plan. The train operation dispatching plan includes functions of “prevention of inter-section forced stop through automatic holding of following trains”, “system-wide coordinated slow speed train operation”, “rapid removal of faulty train from service”, “rapid deployment of standby train”, “early turnback substitution”, and “system-wide train routes automatic adjustment for partial service disruptions”, to carry out rapid train operation adjustments and quickly restore operation.

Step S91, when the dwell time of a train fault handling is long, providing a strategy command of “prevention of inter-section forced stop through automatic holding of following trains”, that is, when the preceding train cannot depart on time due to a fault, automatically holding all subsequent trains at the platforms one station away according to a predetermined strategy, to avoid subsequent trains entering the section and waiting for a long time in the tunnel section.

Step S92, when the dwell time of a train fault handling is long, providing a “system-wide coordinated slow speed train operation” strategy command. Based on the analysis of the time consumed and the impact scope of the faulty train handling, automatically calculating the gradual extension of the stopping time of all trains on the entire line, so as to maintain the train interval within the entire line range, and quickly return to the scheduled train interval after the train fault is recovered.

Step S93, providing a “rapid removal of faulty train from service” strategy command to achieve rapid withdrawal of a faulty train from operation.

Step S94, providing a “rapid setup of standby train” strategy command, which can quickly arrange for a standby train on the main line storage track or in the depot/yard to enter operational passenger service on time and at the designated location.

Step S95, providing an “early turnback substitution” strategy command. When a large train interval occurs in one direction of train travel due to a fault, affecting passenger service, quickly arranging for trains with less passenger demand in the other direction to use the crossover track between the up and down lines for early turnback to compensate for the train interval in the direction of the fault.

Step S96, providing a “system-wide train routes automatic adjustment for partial service disruptions” strategy command. When serious facility and device failures occur in part of the line, causing trains to be unable to pass, providing one-click decision implementation for dispatch, and simultaneously coordinating the arrangement of all trains on the entire line to run on new route paths.

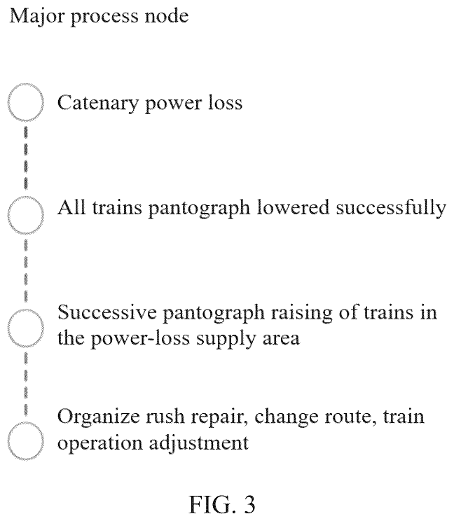

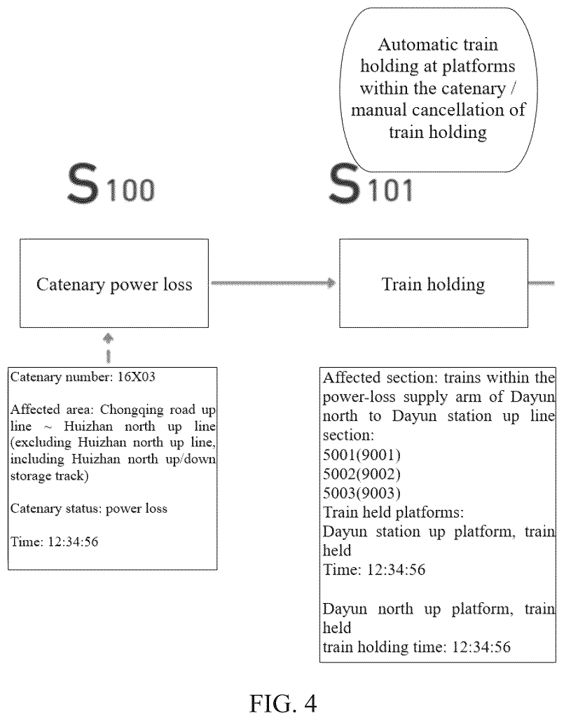

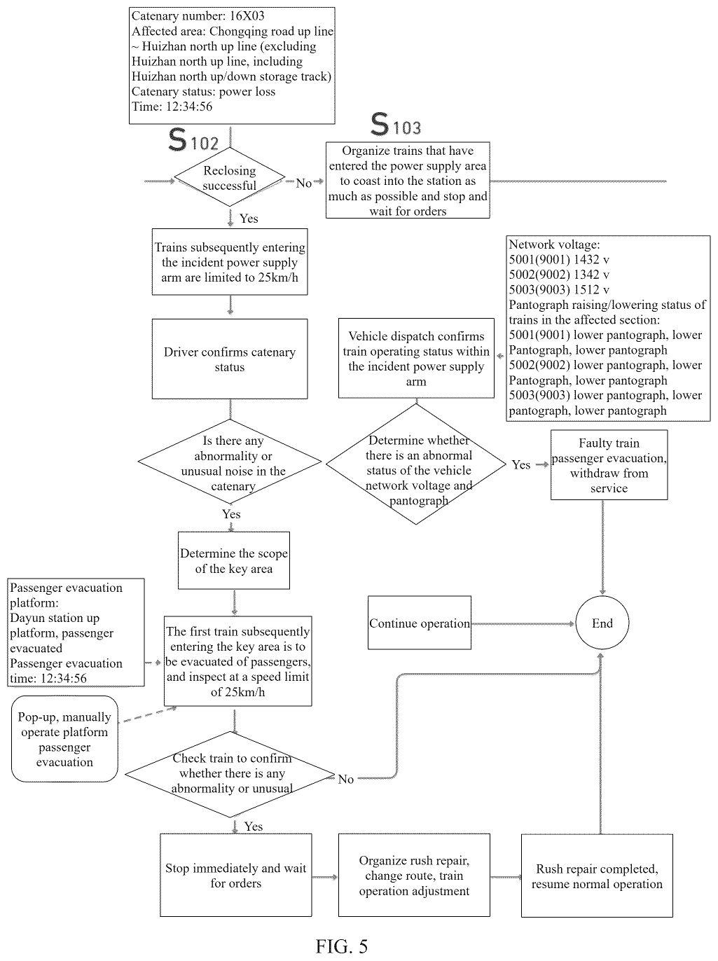

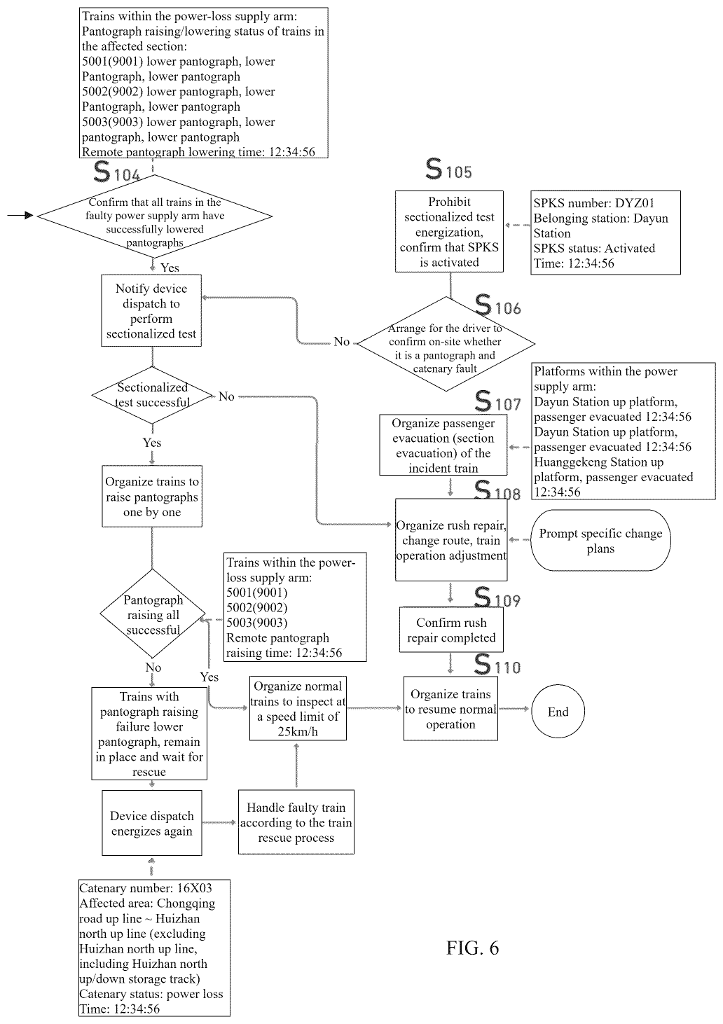

As shown in FIG. 3-6, it provides a catenary power loss preplan flowchart, which is used as an example to introduce the preplan handling process. The preplan handling process covers major signal devices such as turnout failure; catenary power loss failure; failure of main system device of vehicles such as traction, braking, and auxiliary systems; platform screen door person or object trapped and other faults; fire; flooding and other disaster faults, etc.

### Example 1: Catenary Power Loss

Due to the numerous branches of the catenary power loss preplan handling process, the embodiment selects one branch for a brief description.

Step S100, when a catenary power loss fault occurs, giving the number of the specific power supply arm where the catenary loses power, as well as the area affected by the power loss and the time of the power loss.

Step S101, the system automatically identifies the subsequent platforms of the power-loss supply arm and the platforms within the power supply arm, and executes an automatic train holding command.

Step S102, detecting whether the reclosing of the power system is successful. If the reclosing is not successful, proceed to S103.

Step S103, organizing trains that have entered the power supply area to coast into the station as much as possible and stop and wait for orders.

Step S104, the system automatically identifies the trains in the power-loss area, and can initiate a batch pantograph lowering operation on the corresponding trains, and display the pantograph raising/lowering status in real time.

Step S105, prohibiting sectionalized test energization, confirming the SPKS status, and the system displays the corresponding SPKS status.

Step S106, arranging for the driver or train crew to confirm on-site whether it is a pantograph and catenary fault. If it is a pantograph and catenary fault, proceed to S107.

Step S107, organizing passenger evacuation of the incident train, a passenger evacuation command can be sent to the corresponding platform, and the status of the passenger evacuation command is fed back.

Step S108, organizing rush repair, changing the route, and adjusting the train operation. The system, according to the specific number of the power-loss supply arm, gives specific multiple change plans for dispatch decision-making; the dispatch can choose one of the plans and execute the train operation adjustment with one click.

Step S109, manually confirming that the rush repair is completed, and the system simultaneously detects that the power supply is restored.

Step S110, organizing the trains to resume normal operation, and the system can restore the trains to normal operation with one click.

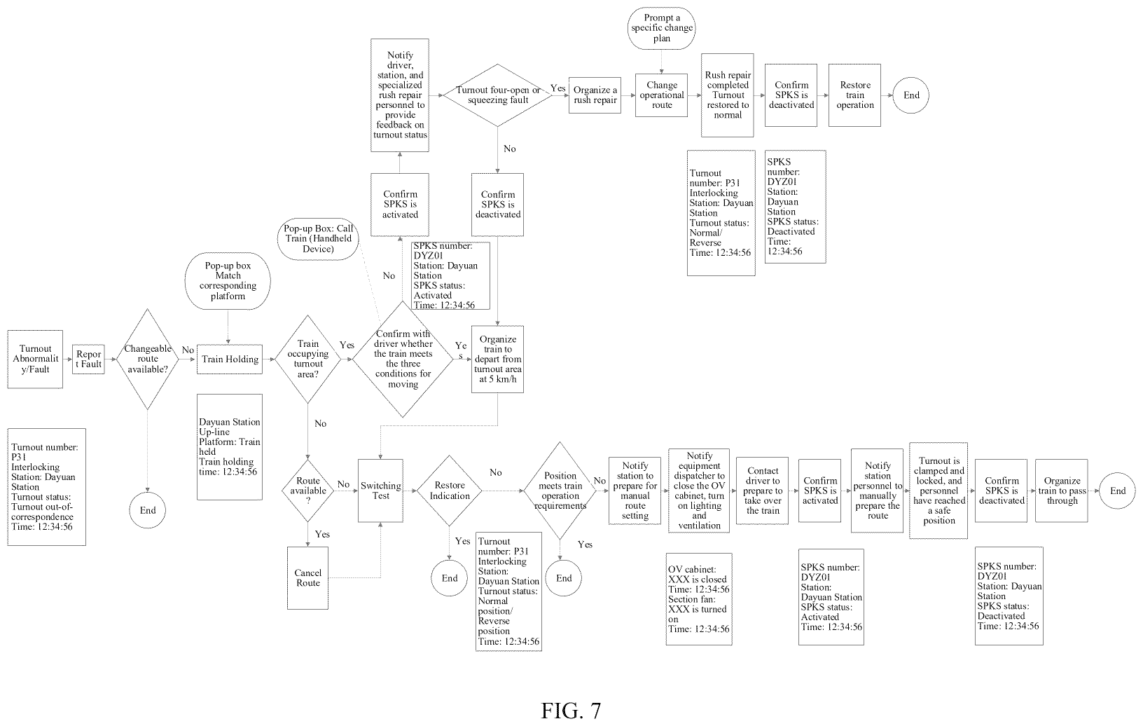

### Example 2: Turnout Fault (See FIG. 7)

The turnout fault flowchart also has numerous branches, and only one branch is briefly described.

Step S200, when a turnout loss of indication fault/squeezing fault occurs, the system automatically provides the number of the faulty turnout, and the time the fault occurred.

Step S201, the system automatically performs a train holding operation for a subsequent platform. Alternatively, a pop-up box may allow a user to select possibly associated up and down line platforms to perform a batch train holding operation, and displays the current train holding status.

Step S202, the system automatically determines whether a train is occupying the turnout area. If so, the driver can be called via the system to confirm whether conditions for moving the train are met.

Step S203, if the conditions for moving the train are not met, after confirmation by dispatch, the corresponding SPKS (staff protection key switch) is activated. And an information message is issued to notify the corresponding maintenance and rush repair personnel.

Step S204, confirm whether the turnout has a four-open fault (a fault state where the switch rail of a turnout is neither closely attached to the left stock rail nor the right stock rail, remaining in a suspended intermediate state where it is not in close contact with either side) or a squeezing fault. If so, organize a rush repair. The system will automatically provide a specific changed operational route based on the fault location, which is executed after one-click confirmation by dispatch.

Step S205, after the rush repair is completed, the system automatically provides feedback on the corresponding status. After confirmation, the SPKS (staff protection key switch) is deactivated, and train operation is restored.

Based on the above example, the main technologies adopted are:

Big data analytics technology is adopted to perform real-time analysis and extraction on multi-disciplinary integrated information, and to perform real-time analysis and provide users with required data. Compared with existing SCADA (Supervisory Control and Data Acquisition) data acquisition and display technology, the present disclosure has a higher degree of intelligence and can automatically extract required data for a user from numerous data. In a traditional mode, dispatch personnel need to query related data, often requiring integration of data from various disciplines, which takes several minutes. After adopting big data analytics technology, the required data is automatically provided to the user, and the time is shortened to a matter of seconds.

A business knowledge graph engine technology is adopted to establish correlation relationships between data from various disciplines based on a business knowledge graph, instantiated to a specific device. When this device fails, the states and controls of related devices that need to be handled are automatically associated. The traditional operation mode is that dispatch personnel need to operate one by one on a human-machine interface and rely on the experience of the dispatch personnel. This changes the process from traditional manual one-by-one operation to an automated linkage with manual confirmation. This improves reaction speed and ensures accuracy.

A process engine SCAP technology is adopted to transform the rules and regulations for dispatch personnel into system process functions. The technology guides dispatch personnel to operate step-by-step according to process nodes, simplifying complex processes. The time for a traditional fault handling is reduced from approximately 15-30 minutes to 5-10 minutes. And it prevents incorrect operations.

A group collaborative handling engine technology is adopted. During an emergency handling process, the system automatically creates a work group of related personnel through a group collaboration module, establishes an efficient feedback mechanism from dispatch command to on-site execution, and switches from a traditional phone call mode to a group work mode. This greatly improves emergency handling efficiency.

Intelligent decision-making technology based on an AI model. The technology provides functions including “Prevention of Inter-section Forced Stop through Automatic Holding of Following Trains,” “System-wide Coordinated Slow Speed Train Operation,” “Rapid Withdrawal of Faulty Train,” “Rapid Deployment of Standby Train,” “Early Turnback Substitution,” and “System-wide Train Routes Automatic Adjustment for Partial Service Disruptions,” to perform rapid train operation adjustments and quickly restore operation. A traditional temporary operational adjustment for fault handling generally requires 10-20 minutes. Through the intelligent decision-making technology of AI technology, the operational adjustment under a fault can be shortened to within 2-10 minutes.

The present embodiment provides a train operation intelligent dispatching system for rail transit faults and emergency situations. The present embodiment focuses on researching the needs of intelligent emergency handling of train dispatching for high efficiency and safety. By collecting, analyzing, and processing multi-source data that may affect train operation, faults affecting operation are discovered in a timely manner; through intelligent analysis, faults that may affect operation are discovered in a timely manner; when an device fault occurs, fault analysis is performed, and according to certain judgment conditions, it is determined whether the fault affects operation. If it does not affect operation, a general fault alarm is generated to prompt dispatch (general fault information); if it affects operation, the system generates a preplan alarm to prompt dispatch (dispatch personnel in control center) to handle it as soon as possible; dispatch can quickly initiate a linkage preplan for fault handling according to the preplan alarm to carry out troubleshooting. In the linkage preplan, intelligent judgment, automatic operation, dynamic feedback of fault-related information, decision-making assistance, and one-click execution functions are provided. The linkage preplan helps dispatch to quickly troubleshoot according to the process and restore operation, thereby improving overall operational efficiency, reducing troubleshooting time, and improving operational safety.

It should be noted that, in this document, relational terms such as first and second are only used to distinguish one entity or operation from another entity or operation, and do not necessarily require or imply any such actual relationship or order between these entities or operations. Moreover, the terms “comprising”, “including” or any other variation thereof are intended to cover a non-exclusive inclusion, so that a process, method, article, or device that comprises a list of elements does not include only those elements but may include other elements not expressly listed or inherent to such process, method, article, or device. An element defined by the statement “comprising a . . . ” does not, without more constraints, preclude the existence of additional identical elements in the process, method, article, or device that comprises the element.

It should be noted that the devices and methods disclosed in the embodiments herein can also be implemented in other ways. The device embodiments described above are merely illustrative. For example, the flowcharts and block diagrams in the figures show the possible architecture, functionality, and operation of devices, methods, and computer program products according to multiple embodiments herein. In this regard, each block in the flowchart or block diagram may represent a module, program, or part of code, which module, program segment, or part of code contains one or more executable instructions for implementing the specified logical function. It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In addition, each functional module in the various embodiments herein may be integrated together to form an independent part, or each module may exist separately, or two or more modules may be integrated to form an independent part.

Although the content of the present disclosure has been described in detail through the above preferred embodiments, it should be understood that the above description should not be considered as a limitation on the present disclosure. After reading the above content, various modifications and substitutions of the present disclosure will be apparent to those skilled in the art. Therefore, the protection scope of the present disclosure should be defined by the appended claims.

1. A train operation intelligent dispatching system, comprising:
a data acquisition and control module, configured to acquire multi-source data affecting train operation;
a data processing module, configured to perform data aggregation and processing on the multi-source data to form multi-source data in a unified data format;
a multi-disciplinary data resource pool, configured to perform real-time saving and updating of the multi-source data in the unified data format, and to store historical multi-source data;
an intelligent fault analysis module, where intelligent fault analysis models for external multi-disciplinary systems are provided, wherein the intelligent fault analysis module is configured to perform fault analysis based on the multi-source data stored in the multi-disciplinary data resource pool, obtain a fault analysis result of a corresponding disciplinary system, and output fault advance warning of the corresponding disciplinary system based on the fault analysis result; wherein the fault advance warning comprises: a general fault alarm and a preplan alarm; and
a process preplan module, configured to provide preplan handling processes corresponding one-to-one with the external multi-disciplinary systems, perform fault troubleshooting on a device in the disciplinary system, and adjust a train operation dispatching plan according to the preplan handling process.

2. The train operation intelligent dispatching system according to claim 1, further comprising: a device initialization module, connected to the data acquisition and control module, wherein the device initialization module is configured to initialize initial information of the train operation intelligent dispatching system, wherein the initial information comprises: an external interface protocol, connection parameters, an acquisition cycle, and configuration parameter loading of each module; and
the data acquisition and control module is configured to communicate with the external multi-disciplinary systems according to the initial information, and collect the multi-source data affecting the train operation.

3. The train operation intelligent dispatching system according to claim 2, wherein the external multi-disciplinary systems comprise: a signaling system, a power supply system, an electromechanical system, a platform screen door system, a fire alarm system (FAS) system, and a vehicle system; and
wherein the multi-source data comprises:
turnout fault, interlocking device fault, catenary switch and electrified state, tunnel fan, fire alarm, platform screen door fault information, civil defense door status, anti-flooding door status, and train traction and auxiliary system fault information.

4. The train operation intelligent dispatching system according to claim 3, further comprising a status buffer zone,
connected to the data acquisition and control module and the data processing module respectively, wherein the status buffer zone is configured to receive and temporarily store the multi-source data sent by the data acquisition and control module.

5. The train operation intelligent dispatching system according to claim 4, wherein
the intelligent fault analysis model is established according to a specific type of external multi-disciplinary system and combined with operating guidance rules of a user.

6. The train operation intelligent dispatching system according to claim 5, wherein according to the general fault alarm, the data acquisition and control module is configured to send a command to a train through the signaling system to allow the train to continue operating until an end of operation before handling.

7. The train operation intelligent dispatching system according to claim 6, wherein the intelligent fault analysis module is configured to:
compare the obtained multi-source data of real-time status quantity and analog quantity with real-time data of the intelligent fault analysis model of the corresponding disciplinary system;
when there is a real-time analog quantity curve or a state quantity change inconsistent with the intelligent fault analysis model of the corresponding disciplinary system, generate a fault advance warning of the disciplinary system, prompting a possible fault in the disciplinary system;
combine big data analytics technology to perform statistical analysis on historical fault situations of similar disciplinary systems, and generate a fault advance warning that may exist in the similar disciplinary systems; and
according to the generated fault advance warnings and in combination with operational guidance rules, analysis is performed on whether faults that have occurred affect operation; when the faults affect operation, a preplan alarm for the fault is generated.

8. The train operation intelligent dispatching system according to claim 7, wherein the process preplan module is configured to:
wherein the preplan handling process comprises major process nodes and detailed process nodes; wherein a relationship between the major process nodes and the detailed process nodes is as follows: the major process node is a key step in entire process, and a step of the detailed process node is configured to be located through the major process node; and the step of the detailed process node is configured to be skipped through the major process node;
different dispatching posts in a dispatching center are configured to open a same process object and perform collaborative preplan handling according to their respective permissions;
each step in the preplan handling process is configured to be marked as executed or unexecuted; and
executed steps need to be clearly distinguished from unexecuted steps by color marking.

9. The train operation intelligent dispatching system according to claim 8, wherein the process preplan module is further configured to:
define a precondition for executing each step in the preplan handling process, and only when the precondition is met, the step is configured to be executed.

10. The train operation intelligent dispatching system according to claim 9, wherein
wherein the process preplan module executes each step, performs necessary precondition checking through the intelligent fault analysis module, displays a status of the precondition, and gives a prompt as to whether a condition for executing the step is met;
according to need of the preplan handling process, define an operation required to be performed by dispatching in each step in the preplan handling process; and
according to a faulty device and a location of the fault, devices required to be operated are automatically determined.

11. The train operation intelligent dispatching system according to claim 10, wherein the process preplan module is further configured to dynamically subscribe to a display of device status of a related precondition required by each step in the preplan handling process; and dynamically subscribe to a display of a status of an operated device after corresponding operations are performed for each step.

12. The train operation intelligent dispatching system according to claim 11, wherein
when operational adjustment is needed, the process preplan module gives a specific operational route adjustment suggestion according to a device of a specific fault for dispatching decision-making; and
when a faulty train needs rescue, the process preplan module automatically searches out leading and following trains according to train information obtained by the data acquisition and control module, gives a suggestion for selecting a rescue train at a train adjustment node in the preplan handling process, and dispatching personnel is configured to select a train as the rescue train to perform subsequent rescue operations.

13. The train operation intelligent dispatching system according to claim 12, wherein
the rescue operation required by the dispatching comprises: calling train crew, train holding, passenger evacuation, pantograph raising/lowering, video retrieval, OV cabinet operation, and turning on a tunnel fan.

14. The train operation intelligent dispatching system according to claim 13, wherein the train operation dispatching plan comprises: “prevention of inter-section forced stop through automatic holding of following trains”, “system-wide coordinated slow speed train operation”, “rapid deployment of faulty train offline”, “rapid deployment of standby train”, “early turnback substitution”, and “system-wide train routes automatic adjustment for partial service disruptions.”

15. The train operation intelligent dispatching system according to claim 14,
wherein
when a fault handling and stay time of the train is long, a strategy command of “prevention of inter-section forced stop through automatic holding of following trains” is provided, wherein when a preceding train is not configured to depart on time due to a fault, all following trains are automatically held at a platform one station away according to a predetermined strategy, to prevent the following trains from entering a section and waiting in a tunnel section for a long time;
when dwell time of the fault handling of the train is long, the strategy command of “system-wide coordinated slow speed train operation” is provided, and a dwell time extension of each of all trains on entire line is automatically calculated according to analyzed fault handling time consumption and influence range of the faulty train, to maintain a train interval within an entire line range, and quickly recover to a train schedule interval after train fault is restored;
a “rapid removal of faulty train from service” strategy command is provided to achieve rapid withdrawal of the faulty train from operation;
a strategy command of “rapid set-up of the standby train” is provided to quickly arrange a standby train on a storage track of a main line or in a depot/yard to put into operation passenger service on time and at a place;
a strategy command of “early turnback substitution” is provided, and when a large train interval occurs in a certain train direction due to a fault and passenger service is affected, a train with less passenger flow demand in the other direction is quickly arranged to use a crossover track between up and down lines to perform turnback in advance to compensate the train interval in fault direction; and
a strategy command of “system-wide train routes automatic adjustment for partial service disruptions” is provided, when severe facility or device faults occur in a partial section of line causing trains to be unable to pass, providing one-click decision implementation for dispatch personnel while coordinating all system-wide trains to switch to new route paths for operation.

16. The train operation intelligent dispatching system according to claim 15, wherein
the general fault alarms and the preplan alarms of all the disciplinary systems are displayed in a unified emergency panorama view.

17. The train operation intelligent dispatching system according to claim 16, wherein a monitoring scope of emergency panoramic view mainly comprises: turnout indication, signal indication, track section occupancy status indication, turnout normal/fault, axle counter normal/failed signaling system device status, staff protection key switch (SPKS) status, train dynamic location, catenary power supply mode station/section fire, section water level, civil defense door status, platform emergency shutdown, platform screen door normal/fault, person or object trapped by the platform screen door, and train normal/fault status.

18. The train operation intelligent dispatching system according to claim 17, wherein when a fault affecting operation occurs, a faulty device in a main display area of an interface of the emergency panoramic view is configured to flash red, and is accompanied by audible and visual alarms.

19. The train operation intelligent dispatching system according to claim 18, wherein through a corresponding device fault in the emergency panoramic view, navigation to a detailed fault page is performed.

20. The train operation intelligent dispatching system according to claim 19, wherein
the fault page displays possible causes of the fault and possible maintenance time estimated based on historical experience values; and
the detailed fault page displays TOP rankings for section parking timeouts, TOP rankings for real-time platform departure delays, train delay deviations, current station entry and exit passenger flows, and current train load factor metrics.

21. The train operation intelligent dispatching system according to claim 20, wherein
a corresponding faulty device quickly opens a preplan process handling interface through the process preplan module to initiate preplan process handling.

22. A method for train operation intelligent dispatching based on the train operation intelligent dispatching system according to claim 1, comprising:
collecting the multi-source data affecting train operation;
performing the data aggregation on the multi-source data, and processing the multi-source data to form the multi-source data in the unified data format;
and performing real-time storage and updating of the multi-source data in the unified data format, and storing the historical multi-source data;
establishing the intelligent fault analysis models for the external multi-disciplinary systems;
performing the fault analysis based on the multi-source data stored in the multi-disciplinary data resource pool to obtain fault analysis results of corresponding disciplinary systems, and outputting fault advance warnings of corresponding devices according to the fault analysis results; wherein when the fault advance warnings affect operation, preplan alarms are generated; and
providing the preplan handling processes corresponding one-to-one with the external multi-disciplinary systems based on the preplan alarm, performing the fault troubleshooting on the devices according to the preplan handling processes, and adjusting train operation dispatching plans.

23. The method for the train operation intelligent dispatching according to claim 22, further comprising:
when the fault advance warnings do not affect operation, generating general fault alarms to prompt dispatching to allow continuation of operation until the end of operation before handling.

24. The method for the train operation intelligent dispatching according to claim 23, further comprising: uniformly displaying the general fault alarms and the preplan alarms of all the disciplinary systems in an emergency panoramic view.
